(19) United States
(12) Patent Application Publication
(10) Pub. No.: US 2008/0193648 A1
(43) Pub. Date: Aug. 14, 2008

(54) Method for Applying Dissolved or Dispersed Substances

(76) Inventors: Heike Becker, Mannheim (DE); Hans-Jurgen Degen, Lorsch (DE); Lidcay Herrera Taboada, Ludwigshafen (DE); Michael Kluge, Worms (DE)

Correspondence Address: OBLON, SPIVAK, MCCLELLAND MAIER & NEUSTADT, P.C., 1940 DUKE STREET, ALEXANDRIA, VA, 22314, US

(21) Appl. No.: 11/911,355

(22) PCT Filed: Apr. 11, 2006
(86) PCT No.: PCT/EP06/61505

§ 371 Date: Oct. 12, 2007

(30) Foreign Application Priority Data
Apr. 12, 2005 (DE) 102005017052.8

(51) Int. Cl. C09D 11/02; C09D 11/10; B05D 5/06

(52) U.S. Cl. 427/288; 106/31.13; 427/256; 524/612

(57) ABSTRACT

A process for applying dissolved or dispersed substances (A) from a formulation in a polar medium, preferably aqueous formulation, to substrates (B) using at least one auxiliary substance (C) by a formulation in a polar medium comprising dissolved or dispersed substance (A) and at least one auxiliary substance (C) being applied to substrate (B),
wherein the pKₐ value of auxiliary substance (C) is higher than that of substrate (B) and of dissolved or dispersed substance (A)
and wherein auxiliary substance (C) is selected from three-dimensional amphoteric core-shell polymers.

The present invention relates to a process for applying dissolved or dispersed substances (A) from a formulation in a polar medium to substrates (B) using at least one auxiliary substance (C) by a formulation in a polar medium comprising dissolved or dispersed substance (A) and at least one auxiliary substance (C) being applied to substrate (B),

wherein the pKₐ value of auxiliary substance (C) is higher than that of substrate (B) and of dissolved or dispersed substance (A)

and wherein auxiliary substance (C) is selected from three-dimensional amphoteric core-shell polymers.

It is often desirous to apply dissolved or dispersed substances to substrates under place and time control, Examples are printing with dissolved or dispersed colorants, in particular printing by the ink jet process for example with dyes, including disperse dyes, or pigments, ideally in many cases to produce needle-sharp images or characters.

What is required is not just the controlled application of the dissolved or dispersed substance, but also the prevention of any unwanted spreading or mixing or migrating.

The prior art proposals are in many cases unsatisfactory.

For instance, JP 2004/155686 and EP 0 997 506 A propose printing up two aqueous formulations, of which one comprises a colorant and the other a pH-sensitive polymer. However, this solution is costly and inconvenient since it requires special printers in many cases. Nor does it ensure that no unwanted spreading takes place between the two printing steps of the first and second aqueous formulations. It has further been determined that, in many cases, the two formulations react with each other in the print head to produce precipitations there whereby the printer is damaged.

JP-A 2000-17209 proposes to print paper for example by using a combination of two inks of which one comprises at least one cationic or amphoteric polymer based on polyethyleneimine and the other comprises an anionic polymer, for example polyacrylic acid. This solution is likewise costly and inconvenient since it requires special printers in many cases. Nor does it ensure that no unwanted spreading takes place between the two printing steps of the first and second inks. It has further been determined that, in many cases, the two inks react with each other in the print head to produce precipitations there whereby the printer is damaged.

EP 0 736 582 proposes using an amphoteric polymer obtainable by free-radical copolymerization of carboxyl-containing or sulfo-containing monomers such as for example acrylic acid, itaconic acid, methacrylic acid, maleic acid, fumaric acid and styrenesulfonic acid with cationic monomers such as for example 2-vinylpyrrolidone, 4-vinylpyrrolidone, allylamine, diallylamine and N-methylaminoethyl methacrylate as a dispersant in ink jet inks. The use of such amphoteric polymers in ink jet inks leads in many cases to an undesirably pronounced increase in viscosity.

U.S. Pat. No. 5,648,405 proposes using polyampholytes obtainable by free-radical copolymerization of ethylenically unsaturated carboxylic acids and basic monomers such as for example N,N-dimethylaminoethyl (meth)acrylate as a dispersant in ink jet inks.

The present invention thus has for its object to provide a process for applying dissolved or dispersed matters which avoids the disadvantages known from the prior art. The present invention further has for its object to provide aqueous formulations whereby a process which avoids the disadvantages known from the prior art can be implemented. The present invention finally has for its object to provide substrates on which dissolved or dispersed substances have been precisely applied.

We have found that this object is achieved by the initially defined process for applying dissolved or dispersed substances (A) from a formulation in a polar medium to substrates (B) using at least one auxiliary substance (C)

by a formulation in a polar medium, preferably an aqueous formulation, comprising dissolved or dispersed substance (A) and at least one auxiliary substance (C) being applied to substrate (B),

wherein the pKₐ value of auxiliary substance (C) is higher than that of substrate (B) and of dissolved or dispersed substance (A)

and wherein auxiliary substance (C) is selected from three-dimensional amphoteric core-shell polymers.

A formulation in a polar medium in the context of the present invention is a formulation which is essentially liquid at room temperature and which may comprise dispersed solids and which comprises at least one polar medium, examples being alcohols such as methanol or isopropanol and in particular water. Preferably, formulations in a polar medium are aqueous formulations and comprise at least 50% by weight of water.

In particular, substrate (B) is contacted with a solution of anionic polymer such as for example poly(meth)acrylic acid or copolymers of styrene and (meth)acrylic acid neither immediately before nor immediately after the applying of formulation in a polar medium and preferably aqueous formulation which comprises dissolved or dispersed substance (A) and at least one auxiliary substance (C). As used herein, immediately before or immediately after the applying is to be understood as referring to a time frame from half an hour before to half an hour after the applying of formulation in a polar medium and preferably of aqueous formulation which comprises dissolved or dispersed substance (A) and at least one auxiliary substance (C).

Suitable substrates (B) are rigid and preferably flexible substrates, flexible substrates being essentially such substrates as can be bent without breaking or irreversibly changing.

Examples of substrates (B) are:

cellulosic materials such as paper, board, card, wood and woodbase, which may each be lacquered or otherwise coated,

metallic materials such as foils, sheets or workpieces composed of aluminum, iron, copper, silver, gold, zinc or alloys thereof, which may each be lacquered or otherwise coated,

silicatic materials such as glass, porcelain and ceramic, which may each be coated,

polymeric materials such as polystyrene, polyamides, polyesters, polyethylene, polypropylene, melamine resins, polyacrylates, polyacrylonitrile, polyurethanes, polycarbonates, polyvinyl chloride, polyvinyl alcohols, polyvinyl acetates, polyvinylpyrrolidones and corresponding copolymers including block copolymers, biodegradable polymers and natural polymers such as gelatin,

leather—both natural and artificial—in the form of smooth leather, nappa leather or suede leather,

comestibles and cosmetics and in particular

textile substrates such as fibers, yarns, threads, knits, wovens, nonwovens and garments composed of polyester, modified polyester, polyester blend fabric, cellulosic materials such as cotton, cotton blend fabric, jute, flax, hemp, and ramie, viscose, wool, silk, polyamide, polyamide blend fabric, polyacrylonitrile, triacetate, acetate, polycarbonate, polypropylene, polyvinyl chloride, blend fabric such as for example polyester-polyurethane blend fabric (Lycra® for example), polyethylene-polypropylene blend fabric, polyester microfibers and glass fiber fabric, and in particular

paper, board, cards, preferably paper having a pKₐ value in the range from 4 to 6 and most preferably transfer paper having a pKₐ value in the range from 4.5 to 5.5.

Examples of flexible substrates are in particular leather, textile substrates, paper, board, cards, preferably paper having a pKₐ value in the range from 4 to 6 and most preferably transfer paper having a pKₐ value in the range from 4.5 to 5.5.

Applying is hereinbelow to be understood as meaning that a formulation in a polar medium, preferably an aqueous formulation which comprises at least one dissolved or dispersed substance (A) and at least one auxiliary substance (C) is contacted in a specific manner with substrate (B), and after the contacting dissolved or dispersed substance (A) adheres to substrate (B). Applying for the purposes of the present invention can be reversible or irreversible, although a possible separation between dissolved or dispersed substance (A) and substrate (B) requires changed external conditions, examples being mechanical force, a drastic change in the pH or a drastic change in the temperature.

Applying a formulation is hereinbelow further to be understood as meaning that only one formulation in a polar medium, preferably an aqueous formulation, is applied at any one location of substrate (B). At any other location of substrate (B), the same or a different formulation in a polar medium, preferably an aqueous formulation, can be applied. Such locations can be in the region of one or more square meters, but they can also be in the range from 1 mm² to 10 mm² or dot-shaped, i.e., in the region of one or a few μm² in size.

In one embodiment of the present invention from 0.01 to 200 g of dissolved or dispersed substance (A) are applied per m² of substrate (B), preferably from 0.03 to 150 g, more preferably from 0.05 to 120 g and most preferably from 0.1 to 50 g per m² of substrate (B).

One embodiment of the present invention embodies the applying by having a formulation in a polar medium and preferably an aqueous formulation which comprises at least one dissolved or dispersed substance (A) and at least one auxiliary substance (C) sprayed, rolled, brushed, pipetted, as with an Eppendorf micropipette for example, and preferably printed, more preferably ink jet printed, to substrate (B).

One embodiment of the present invention comprises printing a formulation in a polar medium and preferably an aqueous formulation which comprises at least one dissolved or dispersed substance (A) and at least one auxiliary substance (C) onto substrate (B) in a printing step by the ink jet process.

In one embodiment of the present invention the polar and preferably aqueous formulation which comprises at least one dissolved or dispersed substance (A) and at least one auxiliary substance (C) comprises a treating liquid, preferably an ink and more preferably an ink jet ink.

Dissolved or dispersed substance (A) preferably comprises such matters or compositions of matter as are solid at room temperature.

In one embodiment of the present invention dissolved or dispersed substance (A) comprises at least one anionic substance. This to be understood as meaning that dissolved or dispersed substance (A) comprises at least one organic anion whose molecular weight is greater than that of the cation required for electrostatic neutralization. Preferably, cations required for electrostatic neutralization are selected from alkali metals such as for example sodium and potassium or from ammonium which, in the realm of the present invention, may be NH₄⁺ or may be substituted by from one to four identical or different substituents selected for example from C₁-C₄-alkyl such as methyl, ethyl, n-propyl, n-butyl and iso-propyl and/or C₂-C₄-ω-hydroxyalkyl, in particular 2-hydroxyethyl singly to 4-tuply substituted. Preferably, the molecular weight of organic anion of dissolved or dispersed substance (A) is in the range from 5 to 10 000 times greater than that of the cation required for electrostatic neutralization, preferably in the range from 100 to 10 000 times greater.

In one embodiment of the present invention dissolved or dispersed substance (A) comprises a substance having at least one SO₃⁻ or OSO₃⁻ group per molecule, for example an organic and preferably aromatic sulfonic acid or disulfonic acid or its corresponding alkali metal or ammonium salt or a sulfated organic compound.

In another embodiment of the present invention dissolved or dispersed substance (A) comprises a substance having COOH groups or its corresponding alkali metal or ammonium salt.

In one embodiment of the present invention dissolved or dispersed substance (A) comprises a colorant or a combination of colorant and dispersant. Specific examples are water-soluble dyes, self-dispersing colorants such as for example pigments modified with one or more sulfonic acid groups or sulfonamide groups per particle, combinations of disperse dye with dispersant and combinations of pigment with dispersant.

Examples of soluble dyes are

C.I. Basic Yellow 2, 37, 78, 94, 96, 97, 98, 102 and 111;

C.I. Basic Orange 2, 60, 62 and 63;

C.I. Basic Red 1, 14, 49, 108 and 111;

C.I. Basic Violet 1, 3, 4, 10, 11, 49 and 50;

C.I. Basic Blue 26, 152, 157, 158 and 161;

C.I. Basic Green 1 and 4;

C.I. Basic Brown 1;

C.I. Acid Orange 7 and 8;

C.I. Acid Blue 9;

C.I. Direct Yellow 4, 5, 11, 15, 127, 131 and 147;

C.I. Direct Red 239 and 254;

C.I. Direct Blue 161, 199, 279 and 281;

C.I. Reactive Red 120.

Further suitable soluble dyes are those of the formula

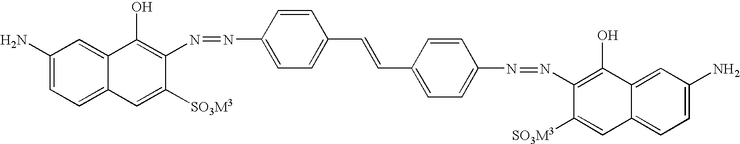

where each M³ is the same or different and selected from alkali metals such as for example lithium and in particular sodium or potassium and also from ammonium, substituted or unsubstituted, for example C₁-C₄-alkyl or co-hydroxy-C₂-C₄-alkyl, in particular 2-hydroxyethyl.

Examples of pigments are organic and inorganic pigments, vat dyes counting as pigments for the purposes of the present invention.

Organic pigments:

| | |
|---|---|
| Monoazo pigments | such as for example C.I. Pigment Brown 25; |
| | C.I. Pigment Orange 5, 13, 36 and 67; C.I. Pigment Red |
| | 1, 2, 3, 5, 8, 9, 12, 17, 22, 23, 31, 48:1, 48:2, 48:3, 48:4, |
| | 49, 49:1, 52:1, 52:2, 53, 53:1, 53:3, 57:1, 63, 112, 146, |
| | 170, 184, 210, 245 and 251; C.I. Pigment Yellow 1, 3, |
| | 73, 74, 65, 97, 151 and 183; |
| Disazo pigments | such as for example C.I. Pigment Orange 16, 34 |
| | and 44; C.I. Pigment Red 144, 166, 214 and 242; |
| | C.I. Pigment Yellow 12, 13, 14, 16, 17, 81, 83, 106, 113, |
| | 126, 127, 155, 174, 176 and 188, |
| Anthanthrone pigments | such as for example C.I. Pigment Red 168 |
| | (C.I. Vat Orange 3); |
| Anthraquinone pigments | such as for example C.I. Pigment Yellow 147 and 177, |
| | C.I. Pigment Violet 31, |
| Anthrapyrimidine pigments | such as for example C.I. Pigment Yellow 108 |
| | (C.I. Vat Yellow 20); |
| Quinacridone pigments | such as for example C.I. Pigment Red 122, 202 and |
| | 206, C.I. Pigment Violet 19; |
| Quinophthalone pigments | such as for example C.I. Pigment Yellow 138, |
| Dioxazine pigments | such as for example C.I. Pigment Violet 23 and 37, |
| Flavanthrone pigments | such as for example C.I. Pigment Yellow 24 |
| | (C.I. Vat Yellow 1), |
| Indanthrone pigments | such as for example C.I. Pigment Blue 60 |
| | (C.I. Vat Blue 4) and 64 (C.I. Vat Blue 6), |
| Isoindoline pigments | such as for example C.I. Pigment Orange 69, |
| | C.I. Pigment Red 260, C.I. Pigment Yellow 139 and 185, |
| Isoindolinone pigments | such as for example C.I. Pigment Orange 61, |
| | C.I. Pigment Red 257 and 260, C.I. Pigment Yellow 109, |
| | 110, 173 and 185, |
| Isoviolanthrone pigments | such as for example C.I. Pigment Violet 31 |
| | (C.I. Vat Violet 1), |
| Metal complex pigments | such as for example C.I. Pigment Yellow 117, 150 and |
| | 153, C.I. Pigment Green 8, |
| Perinone pigments | such as for example C.I. Pigment Orange 43 |
| | (C.I. Vat Orange 7), C.I. Pigment Red 194 |
| | (C.I. Vat Red 15), |
| Perylene pigments | such as for example C.I. Pigment Black 31 and 32, |
| | C.I. Pigment Red 123, 149, 178, 179 (C.I. Vat Red 23), |
| | 190 (C.I. Vat Red 29) and 224, C.I. Pigment Violet 29, |
| Phthalocyanine pigments | such as for example C.I. Pigment Blue 15, 15:1, 15:2, |
| | 15:3, 15:4, 15:6 and 16, C.I. Pigment Green 7 and 36, |
| Pyranthrone pigments | such as for example C.I. Pigment Orange 51, |
| | C.I. Pigment Red 216 (C.I. Vat Orange 4), |
| Thioindigo pigments | such as for example C.I. Pigment Red 88 and 181 |
| | (C.I. Vat Red 1), C.I. Pigment Violet 38 |
| | (C.I. Vat Violet 3), |
| Triarylcarbonium pigments | such as for example C.I. Pigment Blue 1, 61 and 62, |
| | C.I. Pigment Green 1, C.I. Pigment Red 81, 81:1 and |
| | 169, C.I. Pigment Violet 1, 2, 3 and 27, |
| | C.I. Pigment Black 1 (aniline black), |

C.I. Pigment Yellow 101 (aldazine yellow);

C.I. Pigment Brown 22.

Examples of vat dyes (in addition to those already mentioned above):

| | |
|---|---|
| C.I. Vat Yellow | 2, 3, 4, 5, 9, 10, 12, 22, 26, 33, 37, 46, 48, 49 |
| | and 50; |
| C.I. Vat Orange | 1, 2, 5, 9, 11, 13, 15, 19, 26, 29, 30 and 31; |
| C.I. Vat Red | 2, 10, 12, 13, 14, 16, 19, 21, 31, 32, 37, 41, |
| | 51, 52 and 61; |
| C.I. Vat Violet | 2, 9, 13, 14, 15, 17 and 21; |
| C.I. Vat Blue 1 | 3, 5, 10, 12, 13, 14, 16, 17, 18, 19, 20, 22, 25, |
| (C.I. Pigment Blue 66), | 26, 29, 30, 31, 35, 41, 42, 43, 64, 65, 66, 72 |
| | and 74; |
| C.I. Vat Green | 1, 2, 3, 5, 7, 8, 9, 13, 14, 17, 26, 29, 30, 31, |
| | 32, 33, 40, 42, 43, 44 and 49; |
| C.I. Vat Brown | 1, 3, 4, 5, 6, 9, 11, 17, 25, 32, 33, 35, 38, 39, |
| | 41, 42, 44, 45, 49, 50, 55, 57, 68, 72, 73, 80, |
| | 81, 82, 83 and 84; |
| C.I. Vat Black | 1, 2, 7, 8, 9, 13, 14, 16, 19, 20, 22, 25, 27, 28, |
| | 29, 30, 31, 32, 34, 36, 56, 57, 58, 63, 64 and |
| | 65; |

inorganic pigments:

white pigments such as for example titanium dioxide (C.I. Pigment White 6), zinc white, pigment grade zinc oxide; zinc sulfide, lithopone; lead white, barium sulfate,

black pigments such as for example iron oxide black (C.I. Pigment Black 11), iron manganese black, spinel black (C.I. Pigment Black 27); carbon black (C.I. Pigment Black 7),

chromatic pigments such as for example chromium oxide, chromium oxide hydrate green, chromium green (C.I. Pigment Green 48), cobalt green (C.I. Pigment Green 50), ultramarine green, cobalt blue (C.I. Pigment Blue 28 and 36); ultramarine blue; iron blue (C.I. Pigment Blue 27); manganese blue; ultramarine violet, cobalt and manganese violet, iron oxide red (C.I. Pigment Red 101), cadmium sulfoselenide (C.I. Pigment Red 108); molybdate red (C.I. Pigment Red 104), ultramarine red,

iron oxide brown, mixed brown, spinel and corundum phases (C.I. Pigment Brown 24, 29 and 31), chromium orange,

iron oxide yellow (C.I. Pigment Yellow 42), nickel titanium yellow (C.I. Pigment Yellow 53, C.I. Pigment Yellow 157 and 164), chromium titanium yellow, cadmium sulfide and cadmium zinc sulfide (C.I. Pigment Yellow 37 and 35), chromium yellow (C.I. Pigment Yellow 34), zinc yellow, alkaline earth metal chromate; Naples yellow, bismuth vanadate (C.I. Pigment Yellow 184),

interference pigments such as for example metal effect pigments based on coated metal platelets, pearl luster pigments based on metal-oxide-coated mica platelets, and liquid crystal pigments.

Preferred pigments are monoazo pigments (in particular laked BONS pigments, Naphthol AS pigments), disazo pigments (in particular diaryl yellow pigments, bisacetoacetanilide pigments, disazopyrazolone pigments), quinacridone pigments, quinophthalone pigments, perinone pigments, phthalocyanine pigments, triarylcarbonium pigments (alkali blue pigments, laked rhodamines, dye salts with complex anions), isoindoline pigments and carbon blacks.

Examples of particularly preferred pigments are specifically: C.I. Pigment Yellow 138, C.I. Pigment Red 122, C.I. Pigment Violet 19, C.I. Pigment Blue 15:3 and 15:4, C.I. Pigment Black 7, C.I. Pigment Orange 5, 38 and 43 and C.I. Pigment Green 7.

Examples of disperse dyes are substantially water-insoluble colorants which are readily soluble in at least one organic medium such as organic polymer for example, in particular solvent and disperse dyes such as for example

| | |
|---|---|
| C.I. Disperse Yellow | 1, 2, 3, 4, 5, 6, 7, 8, 9, 10, 11, 11:1, 12, 13, 14, 15, 16, 17, 18, |
| | 19, 20, 21, 22, 23, 24, 25, 26, 27, 28, 29, 30, 31, 32, 33, 34, 35, |
| | 36, 37, 38, 39, 40, 41, 42, 43, 44, 45, 46, 47, 48, 49, 50, 51, 52, |
| | 53, 54, 55, 56, 57, 58, 59, 60, 61, 62, 63, 64, 65, 66, 67, 68, 69, |
| | 70, 71, 72, 73, 74, 75, 76, 77, 78, 79, 80, 81, 82, 83, 84, 85, 86, |
| | 87, 88, 89, 90, 91, 92, 93, 94, 95, 96, 97, 98, 99, 100, 101, 102, |
| | 103, 104, 105, 106, 107, 108, 109, 110, 111, 112, 113, 114, |
| | 115, 116, 117, 118, 119, 120, 121, 179, 180, 181, 182, 183, |
| | 184, 184:1, 198, 200, 201, 202, 203, 204, 205, 206, 207, 208, |
| | 209, 210, 211, 212, 213, 214, 215, 216, 217, 218, 219, 220, |
| | 221, 222, 223, 224, 225, 226, 227 and 228; |
| C.I. Disperse Orange | 1, 2, 3, 3:3, 4, 5, 6, 7, 8, 9, 10, 11, 12, 13, 14, 15, 16, 17, 18, |
| | 19, 20, 21, 22, 23, 24, 25, 25:1, 26, 27, 28, 29, 30, 31, 32, 33, |
| | 34, 35, 36, 37, 38, 39, 40, 41, 41:1, 42, 43, 44, 45, 46, 47, 48, |
| | 49, 50, 51, 52, 53, 54, 55, 56, 57, 58, 59, 60, 61, 62, 63, 64, 65, |
| | 66, 67, 68, 69, 70, 71, 72, 73, 74, 75, 76, 77, 78, 79, 80, 81, 82, |
| | 83, 84, 85, 86, 87, 88, 89, 90, 91, 126, 127, 128, 129, 130, 131, |
| | 136, 137, 138, 139, 140, 141, 142, 143, 145, 146, 147 and 148; |
| C.I. Disperse Red | 1, 2, 3, 4, 5, 5:1, 6, 7, 8, 9, 10, 11, 12, 13, 14, 15, 16, 17, 18, |
| | 19, 20, 21, 22, 23, 24, 25, 26, 27, 28, 29, 30, 30:1, 31, 32, 33, |
| | 34, 35, 36, 38, 39, 40, 41, 43, 43:1, 46, 48, 50, 51, 52, 53, 54, |
| | 55, 55:1, 56, 58, 59, 60, 61, 63, 65, 66, 69, 70, 72, 73, 74, 75, |
| | 76, 77, 79, 80, 81, 82, 84, 85, 86, 86:1, 87, 88, 89, 90, 91, 92, |
| | 93, 94, 96, 97, 98, 100, 102, 103, 104, 105, 106, 107, 108, 109, |
| | 110, 111, 112, 113, 115, 116, 117, 118, 120, 121, 122, 123, |
| | 125, 126, 127, 128, 129, 130, 131, 132, 133, 134, 135, 136, |
| | 137, 138, 139, 140, 141, 142, 143, 144, 145, 146, 147, 148, |
| | 149, 150, 151, 151:1, 152, 153, 154, 155, 156, 157, 158, 159, |
| | 160, 161, 162, 163, 164, 165, 166, 167, 167:1, 168, 169, 170, |
| | 171, 172, 173, 174, 175, 176, 177, 178, 179, 180, 181, 182, |
| | 183, 184, 185, 186, 187, 188, 189, 190, 190:1, 191, 191:1, 192, |
| | 193, 194, 195, 211, 223, 224, 273, 274, 275, 276, 277, 278, |
| | 279, 280, 281, 302:1, 305, 306, 307, 308, 309, 310, 311, 312, |
| | 313, 314, 315, 316, 317, 318, 319, 320, 321, 322, 323, 324, |
| | 325, 326, 327, 328, 329, 330, 331, 332, 333, 334, 335, 336, |
| | 338, 339, 340, 341, 342, 343, 344, 346, 347, 348, 349, 352, |
| | 356 and 367; |
| C.I. Disperse Violet | 1, 2, 3, 4, 4:1, 5, 6, 7, 8, 9, 10, 11, 12, 13, 14, 15, 16, 17, 18, |
| | 19, 20, 21, 22, 23, 24, 25, 26, 27, 28, 29, 31, 33, 34, 35, 36, 37, |
| | 38, 39, 40, 41, 42, 43, 44, 45, 46, 47, 48, 49, 50, 51, 52, 53, 54, |
| | 55, 56, 57, 58, 59, 60, 70, 81, 86, 87, 88, 89, 91, 92, 93, 94, 96 |
| | and 97; |
| C.I. Disperse Blue | 1, 1:1, 2, 3, 3:1, 4, 5, 6, 7, 7:1, 8, 9, 10, 11, 12, 13, 13:1, 14, 15, |
| | 16, 17, 18, 19, 20, 21, 22, 23, 23:1, 24, 25, 26, 27, 28, 29, 30, |
| | 31, 32, 33, 34, 35, 36, 38, 39, 40, 42, 43, 44, 45, 47, 48, 49, 51, |
| | 52, 53, 54, 55, 56, 58, 60, 60:1, 61, 62, 63, 64, 64:1, 65, 66, 68, |
| | 70, 72, 73, 75, 76, 77, 79, 80, 81, 81:1, 82, 83, 84, 85, 86, 87, |
| | 88, 89, 90, 91, 92, 93, 94, 95, 96, 97, 98, 99, 100, 101, 102, |
| | 103, 104, 105, 106, 107, 108, 109, 111, 112, 113, 114, 115, |
| | 116, 117, 118, 119, 121, 122, 123, 124, 125, 126, 127, 128, |
| | 130, 131, 132, 133, 134, 136, 137, 138, 139, 140, 141, 142, |
| | 143, 144, 145, 146, 147, 148, 149, 150, 151, 152, 153, 154, |
| | 155, 156, 158, 159, 160, 161, 162, 163, 164, 165, 165:2, 166, |
| | 167, 168, 169, 170, 171, 172, 173, 174, 175, 195, 281, 282, |
| | 283, 283:1, 284, 285, 286, 287, 288, 289, 290, 291, 292, 293, |
| | 294, 316, 317, 318, 319, 320, 321, 322, 323, 324, 325, 326, |
| | 327, 328, 329, 330, 331, 332, 333, 334, 335, 336, 337, 338, |
| | 339, 340, 341, 342, 343, 344, 345, 346, 347, 349, 351 and 359; |
| C.I. Disperse Green | 1, 2, 5, 6 and 9; |
| C.I. Disperse Brown | 1, 2, 3, 4, 4:1, 5, 7, 8, 9, 10, 11, 18, 19, 20 and 21; |
| C.I. Disperse Black | 1, 3, 4, 5, 6, 7, 8, 9, 10, 11, 12, 13, 14, 15, 20, 22, 24, 25, 26, |
| | 27, 28, 29, 29:1, 30, 31, 32, 33, 34 and 36; |
| C.I. Solvent Yellow | 2, 3, 7, 12, 13, 14, 16, 18, 19, 21, 25, 25:1, 27, 28, 29, 30, 33, |
| | 34, 36, 42, 43, 44, 47, 56, 62, 72, 73, 77, 79, 81, 82, 83, 83:1, |
| | 88, 89, 90, 93, 94, 96, 98, 104, 107, 114, 116, 117, 124, 130, |
| | 131, 133, 135, 141, 143, 144, 145, 146, 157, 160:1, 161, 162, |
| | 163, 167, 169, 172, 173, 176, 179, 180, 181, 182, 183, 184, |
| | 185, 186, 187, 189, 190 and 191; |
| C.I. Solvent Orange | 1, 2, 3, 4, 5, 7, 11, 14, 20, 23, 25, 31A, 40:1, 41, 45, 54, 56, 58, |
| | 60, 62, 63, 70, 75, 77, 80, 81, 86, 99, 102, 103, 105, 106, 107, |
| | 108, 109, 110, 111, 112 and 113; |
| C.I. Solvent Yellow | 2, 3, 7, 12, 13, 14, 16, 18, 19, 21, 25, 25:1, 27, 28, 29, 30, 33, |
| | 34, 36, 42, 43, 44, 47, 56, 62, 72, 73, 77, 79, 81, 82, 83, 83:1, |
| | 88, 89, 90, 93, 94, 96, 98, 104, 107, 114, 116, 117, 124, 130, |
| | 131, 133, 135, 141, 143, 144, 145, 146, 157, 160:1, 161, 162, |
| | 163, 167, 169, 172, 173, 176, 179, 180, 181, 182, 183, 184, |
| | 185, 186, 187, 189, 190 and 191; |
| C.I. Solvent Orange | 1, 2, 3, 4, 5, 7, 11, 14, 20, 23, 25, 31A, 40:1, 41, 45, 54, 56, 58, |
| | 60, 62, 63, 70, 75, 77, 80, 81, 86, 99, 102, 103, 105, 106, 107, |
| | 108, 109, 110, 111, 112 and 113; |
| C.I. Solvent Red | 1, 2, 3, 4, 8, 16, 17, 18, 19, 23, 24, 25, 26, 27, 30, 33, 35, 41, |
| | 42, 45, 48, 49, 52, 68, 69, 72, 73, 83:1, 84:1, 89, 90, 90:1, 91, |
| | 92, 106, 109, 111, 118, 119, 122, 124, 125, 127, 130, 132, 135, |
| | 141, 143, 145, 146, 149, 150, 151, 155, 160, 161, 164, 164:1, |
| | 165, 166, 168, 169, 172, 175, 179, 180, 181, 182, 195, 196, |
| | 197, 198, 207, 208, 210, 212, 214, 215, 218, 222, 223, 225, |
| | 227, 229, 230, 233, 234, 235, 236, 238, 239, 240, 241, 242, |
| | 243, 244, 245, 247 and 248; |
| C.I. Solvent Violet | 2, 8, 9, 11, 13, 14, 21, 21:1, 26, 31, 36, 37, 38, 45, 46, 47, 48, |
| | 49, 50, 51, 55, 56, 57, 58, 59, 60 and 61; |
| C.I. Solvent Blue | 2, 3, 4, 5, 7, 18, 25, 26, 35, 36, 37, 38, 43, 44, 45, 48, 51, 58, |
| | 59, 59:1, 63, 64, 67, 68, 69, 70, 78, 79, 83, 94, 97, 98, 99, 100, |
| | 101, 102, 104, 105, 111, 112, 122, 124, 128, 129, 132, 136, |
| | 137, 138, 139 and 143; |
| C.I. Solvent Green | 1, 3, 4, 5, 7, 28, 29, 32, 33, 34 and 35; |
| C.I. Solvent Brown | 1, 3, 4, 5, 12, 20, 22, 28, 38, 41, 42, 43, 44, 52, 53, 59, 60, 61, |
| | 62 and 63; |
| C.I. Solvent Black | 3, 5, 5:2, 7, 13, 22, 22:1, 26, 27, 28, 29, 34, 35, 43, 45, 46, 48, |
| | 49 and 50. |

In one embodiment of the present invention dispersed substance (A) comprises a combination of dispersant and disperse dye or pigment wherein disperse dye and pigment are themselves not anionic and do not comprise any COOH groups or SO₃⁻ or OSO₃⁻ groups either and the dye/pigment is dispersed by a dispersant which is anionic, preferably comprises COOH groups or SO₃⁻ or OSO₃⁻ groups.

Examples of particularly suitable dispersants having SO₃⁻ groups are lignin sulfonates, naphthalene mono- and -disulfonic acids, naphthalenesulfonic acid-formaldehyde condensation products and in particular mixtures of alkali metal salts of fatty acids with naphthalenesulfonic acid-formaldehyde condensation products and also dispersants known from U.S. Pat. No. 5,186,846.

Examples of particularly suitable dispersants having OSO₃⁻ groups are sulfated and alkoxylated, in particular ethoxylated and if appropriate alkylated or arylated phenols, more preferably compounds of the general formulae I a and I b

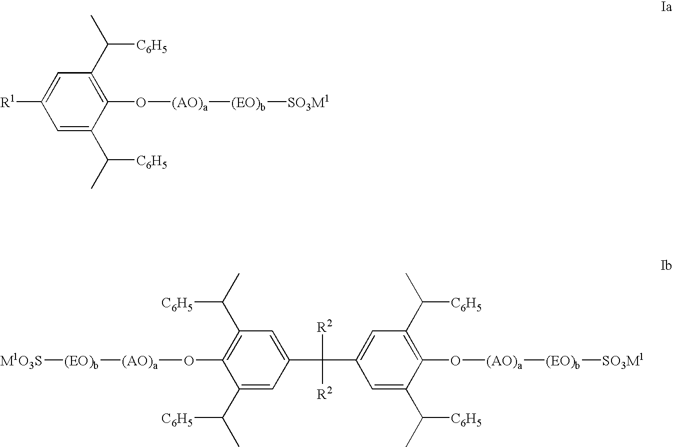

where
R¹ is selected from hydrogen, phenyl, CH(CH₃)C₆H₅ and
C₁-C₁₀-alkyl, branched or unbranched, such as methyl, ethyl, n-propyl, iso-propyl, n-butyl, iso-butyl, sec-butyl, tert-butyl, n-pentyl, iso-pentyl, sec-pentyl, neo-pentyl, 1,2-dimethylpropyl, iso-amyl, n-hexyl, iso-hexyl, sec-hexyl, n-heptyl, n-octyl, 2-ethylhexyl, n-nonyl, n-decyl, more preferably C₁-C₄-alkyl such as methyl, ethyl, n-propyl, n-butyl and especially iso-propyl,
R² in each occurrence is the same or different and selected from hydrogen, phenyl and C₁-C₁₀-alkyl, branched or unbranched, such as methyl, ethyl, n-propyl, iso-propyl, n-butyl, iso-butyl, sec-butyl, tert-butyl, n-pentyl, iso-pentyl, sec-pentyl, neo-pentyl, 1,2-dimethylpropyl, iso-amyl, n-hexyl, iso-hexyl, sec-hexyl, n-heptyl, n-octyl, 2-ethylhexyl, n-nonyl, n-decyl, more preferably C₁-C₄-alkyl such as methyl, ethyl, n-propyl, n-butyl and especially methyl or ethyl,
AO represents alkylene oxide, preferably C₃-C₅-alkylene oxide, for example butylene oxide, pentylene oxide and especially propylene oxide (C₃H₆O),
EO represents ethylene oxide (CH₂CH₂O),
a in each occurrence is the same or different and selected from numbers in the range from 0 to 150, and preferably up to 20, and as an average (a number average) may also be a non-whole number,
b in each occurrence is the same or different and selected from numbers in the range from 15 to 250, preferably in the range from 20 to 200 and more preferably up to 35, and as an average (a number average) may also be a non-whole number,
   where b≧a,
M¹ in each occurrence is the same or different and selected from ammonium and alkali metals, for example lithium, cesium, rubidium and preferably sodium and potassium.

The preparation of compounds of the general formula I a and I b is known per se and accomplished for example by reaction of phenols of the general formula II a

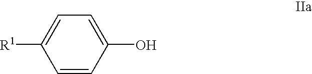

or bisphenols of the general formula II b

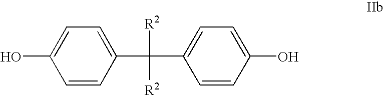

in each of which the variables are each as defined above, with 2, 3 or 4 equivalents of styrene in the presence of acidic catalyst, preferably Lewis acid. This is followed by reaction with if appropriate with alkylene oxide, in particular with C₃-C₅-alkylene oxide, and thereafter with ethylene oxide, for example in the presence of acidic or basic catalyst. To prepare compounds of the general formula I a or I b where a is =0, the reaction with ethylene oxide is carried out immediately and no reaction with alkylene oxide such as C₃-C₅-alkylene oxide for example is carried out. This may be followed by a full or partial sulfation, for example with sulfating reagents, in particular sulfur trioxide or chlorosulfonic acid, and thereafter by partial or full neutralization with alkali metal hydroxide.

The weight ratio of dispersant to disperse dye/pigment may be in the range from 1:10 to 10:1, preferably in the range from 1:5 to 5:1 and more preferably in the range from 1:2 to 2:1.

One embodiment of the present invention utilizes not just one dispersant but a mixture of at least two dispersants of which at least one comprises COOH groups or SO₃⁻ or OSO₃⁻ groups and at least one comprises no COOH groups or SO₃⁻ or OSO₃⁻ groups.

Examples of particularly suitable dispersants comprising no COOH groups or SO₃⁻ or OSO₃⁻ groups are nonsulfated analogs of compounds of the general formula I a and I b wherein the O—SO₃M group is replaced by a hydroxyl group.

Formulation in polar medium, preferably aqueous formulation, used in the process of the present invention further comprises at least one auxiliary substance (C) whose pKₐ value is greater than that of substrate (B) and of dissolved or dispersed substance (A) and which is selected from three-dimensional, i.e., preferably non-linear, amphoteric core-shell polymers. For example, the pKₐ value of auxiliary substance (C) may be from 1 to 15 units and preferably from 1 to 6 units greater than the pKₐ value of substrate (B) and from 1 to 15 units and preferably from 1 to 6 units greater than the pKₐ value of dissolved or dispersed substance (A).

In one embodiment of the present invention auxiliary substance (C) utilized in the process of the present invention comprises at least two pKₐ values. When auxiliary substance (C) comprises at least two pKₐ values, preferably two pKₐ values and more preferably all pKₐ values of auxiliary substance (C) are from 1 to 15 units and preferably from 1 to 6 units greater than the pKₐ value of substrate (B).

pKₐ values of auxiliary substance (C), substrate (B) and dissolved or dispersed substance (A) are determinable by conventional methods, for example titrimetrically by determining the half neutralization potentials.

Three-dimensional in connection with auxiliary substance (C) is preferably to be understood as meaning that auxiliary substance (C) comprises partially crosslinked amphoteric core-shell polymers, partially crosslinked meaning that at least one amphoteric core-shell polymer has been reacted with from 0.1% to 10% by weight of at least one at least bifunctional crosslinker or at least one nitrogenous polymer with from 0.1% to 10% by weight of at least one at least bifunctional crosslinker. Suitable at least bifunctional crosslinkers are for example tri- and preferably bifunctional compounds which may be low in molecular weight or preferably high in molecular weight, in which case low molecular weight crosslinkers have molecular weights in the range from 80 to 500 g/mol and high molecular weight crosslinkers have a molecular weight above 500 g/mol.

Amphoteric in connection with auxiliary substance (C) is to be understood as meaning that auxiliary substance (C), prior to the point in time when formulation in polar medium and preferably aqueous formulation which comprises auxiliary substance (C) and dissolved or dispersed substance (A) is applied to substrate (B), comprises at least one charged, preferably cationically charged, district and further comprises at least one uncharged or preferably anionic district. The charge distribution in auxiliary substance (C) preferably changes during the applying of formulation in polar medium and preferably aqueous formulation which comprises auxiliary substance (C) and dissolved or dispersed substance (A) in particular during the contacting. Preferably, the charge distribution in auxiliary substance (C) changes during the applying such that the relative fraction of cationic charge increases or the relative fraction of anionic charge decreases.

Core-shell polymers in one embodiment of the present invention are such polymers as have a spatially inhomogeneous composition. Preferably, core-shell polymers comprise a charged, preferably cationically charged, core which is preparable for example by (co)polymerization of one or more nitrogenous (co)monomers and which comprises one of the districts described in the preceding paragraph and a shell which may also be referred to as a sheath or envelope and which is uncharged or preferably negatively charged before the applying to substrate (B).

In one embodiment of the present invention the shell/sheath/envelope may be nonpolymeric. This covers such shells/sheaths/envelopes as are applied to the core by polymer-analogous reaction, viz., by reaction with one or more low molecular weight reagents for example with a molecular weight in the range from 30 to 500 g/mol.

In another embodiment of the present invention the shell is polymeric. This covers such shells/sheaths/envelopes as are applied to the core by polymer-analogous reaction, viz., by reaction with one or more high molecular weight reagents for example with a molecular weight above 500 g/mol and in another embodiment such shells/sheaths/envelopes as are applied to the core by graft polymerization.

The weight ratio of core to shell in one embodiment of the present invention is in the range from 1:0.1 to 1:10 and preferably in the range from 1:0.2 to 1:2.

In one embodiment of the present invention three-dimensional amphoteric core-shell polymer comprises a partially crosslinked chemically modified polymer which has been chemically modified for example by one or more polymer-analogous reactions of which one may be for example a Michael addition or a carboxymethylation, for example in the form of a nucleophilic substitution.

In one embodiment of the present invention auxiliary substance (C) is obtainable by reaction of
(C1) at least one nitrogenous polymer selected from polyalkylenepolyamines, polyamidoamines, ethyleneimine-grafted polyamidoamines, polyetheramines, with
(C2) at least one carboxyalkylating reagent selected from
   α,β-unsaturated carboxyl compounds whose carboxyl groups may be free or capped, α-halocarboxyl compounds whose carboxyl groups may be free or capped, glycidylcarboxyl compounds whose carboxyl groups may be free or capped,
   cyanohydrins and mixtures of at least one aldehyde and at least one alkali metal cyanide,
(C3) and if appropriate at least one at least bifunctional crosslinker whose functional groups are selected from halohydrin, glycidyl, aziridine or isocyanate units or halogen atoms.

Nitrogenous polymers (C1) are selected for example from polyalkylenepolyamines, polyamidoamines, ethyleneimine-grafted polyamidoamines and polyetheramines.

(C1) polyalkylenepolyamines shall herein be preferably understood as referring to such polymers as comprise at least six nitrogen atoms and at least five C₂-C₁₀-alkylene units, preferably C₂-C₃-alkylene units, per molecule, for example pentaethylenehexamine, and in particular polyethyleneimines. Polyethyleneimines may have for example an average molecular weight (M_{w}) of at least 300 g/mol, and preferably the average molecular weight of polyethyleneimines is in the range from 800 to 2 000 000 g/mol, more preferably in the range from 20 000 to 1 000 000 g/mol and most preferably in the range up to 750 000 g/mol, determined by light scattering
(C1) polyalkylenepolyamines may be partially amidated, obtainable for example by reaction of above-described polyalkylenepolyamines with C₁-C₃₀-carboxylic acids or C₁-C₃₀-carboxylic acid derivatives such as for example C₁-C₃₀-carboxylic esters, in particular C₁-C₁₀-alkyl C₁-C₃₀-carboxylates, C₁-C₃₀-carboxylic anhydrides or C₁-C₃₀-carbonyl halides such as for example C₁-C₂₈-carbonyl chlorides. (C1) polyalkylene polyamines may be amidated for subsequent reactions, preferably to an extent in the range from 1 to 30 mol % and more preferably to an extent in the range up to 20 mol %, based on amidatabie nitrogen atoms in (C1). It is likewise possible to amidate by reacting polyalkylenepolyamine with C₁-C₂₈-alkyldiketene. Preferably, amidated polyalkylenepolyamines comprise free NH groups in order that they may be reacted with (C2) and if appropriate (C3). Suitable C₁-C₃₀-carboxylic acids for the amidation of above-described polyalkylenepolyamines are for example formic acid, acetic acid, propionic acid, benzoic acid, lauric acid, paimitic acid, stearic acid, oleic acid, linoleic acid and behenic acid, particularly suitable C₁-C₃₀-carboxylic acid derivatives are the anhydrides and chlorides of the above-identified C₁-C₃₀-carboxylic acids. Particularly suitable C₁-C₁₀-alkyl C₁-C₃₀-carboxylates are the methyl and ethyl esters of the above-identified C₁-C₃₀-carboxylic acids.

Polyalkyleneamines can also be used as (C1) in partly quaternized (alkylated) form. Suitable quaternizing (alkylating) agents are for example alkyl halides, in particular C₁-C₁₀-alkyl chloride such as methyl chloride, methyl bromide, methyl iodide, ethyl chloride, ethyl bromide, n-butyl chloride, tert-butyl chloride, n-hexyl chloride, also epichlorohydrin, dimethyl sulfate, diethyl sulfate and benzyl chloride. When quaternized (alkylated) polyalkylenepolyamines are used as (C1), the degree of quaternization (alkylation) is preferably in the range from 1 to 30 mol % and more preferably in the range up to 20 mol %, based on quaternizable (alkylatable) nitrogen atoms in (C1).

Polyalkyleneamines and in particular polyethyleneimines may further be used as (C1) after partial alkoxylation with C₂-C₂₂-epoxides. Examples of suitable C₂-C₂₂-epoxides are ethylene oxide, propylene oxide, n-hexylene oxide, styrene oxide, prepared for example in the presence of bases as a catalyst. When polyalkylenepolyamines partly alkoxyated with C₂-C₂₂-epoxides are used as (C1), the degree of alkoxylation is preferably in the range from 1 to 30 mol % and more preferably in the range up to 20 mol %, based on alkoxylatable nitrogen atoms in (C1).

Polyamidoamines are further useful as (C1). Useful polyamidoamines are obtainable for example by reaction of C₄-C₁₀-dicarboxylic acids with polyalkylenepolyamines which preferably comprise from 3 to 10 basic nitrogen atoms in the molecule. Useful dicarboxylic acids are for example succinic acid, maleic acid, adipic acid, glutaric acid, suberic acid, sebacic acid or terephthalic acid. Mixtures of the aforementioned dicarboxylic acids can be used as well, for example mixtures of adipic acid and glutaric acid or mixtures of maleic acid and adipic acid. Adipic acid is preferably used for preparing polyaminoamines useful as (C1). Useful polyalkylenepolyamines, which are condensed with aforementioned dicarboxylic acids, are for example diethylenetriamine, triethylenetetramine, dipropylenetriamine, tripropylenetetramine, dihexamethylenetriamine, aminopropylethylenediamine and bisaminopropylethylenediamine. Aforementioned polyalkylenepolyamines can also be used in the form of mixtures in the preparation of polyamidoamine useful as (C1). The preparation of polyamidoamine useful as (C1) is preferably effected in the absence of a solvent, but may also be accomplished, if appropriate, in inert solvents. The condensation of dicarboxylic acid with polyalkylenepolyamine is effected at elevated temperatures, for example in the range from 120 to 220° C. The water of reaction is distilled out of the reaction mixture. The condensation may, if appropriate, be carried out in the presence of lactones or lactams of carboxylic acids having from 4 to 8 carbon atoms. The amount of polyalkylenepolyamine used is generally in the range from 0.8 to 1.4 mol per mole of dicarboxylic acid. Polyamidoamines thus obtainable have primary and secondary NH groups and are soluble in water.

Component (C1) may further be an ethyleneimine-grafted polyamidoamine. Ethyleneimine-grafted polyamidoamines are preparable by the action of ethyleneimine on above-described polyamidoamine in the presence of Brönstedt acids or Lewis acids, examples being sulfuric acid, phosphoric acid or boron trifluoride etherate. Ethyleneimine becomes grafted onto the polyamidoamine under the conditions described. For instance, from 1 to 10 ethyleneimine units can be grafted on per basic nitrogen atom in the polyamidoamine; that is, about 10 to 500 parts by weight of ethyleneimine are used per 100 parts by weight of polyamidoamine.

Polyetheramines known from DE-A 29 16 356 for example are further useful as (C1). Polyetheramines are obtainable by condensation of di- and polyamines with chlorohydrin ethers at elevated temperatures such as 50 to 150° C. for example.

Polyamines used as starting material to prepare polyetheramines may comprise up to 10 nitrogen atoms per molecule.

Chlorohydrin ethers used as starting material to prepare polyetheramines are prepared for example by reacting epihalohydrin, preferably epichlorohydrin, with at least one at least dihydric alcohol, preferably with dihydric alcohols having from 2 to 5 carbon atoms, alkoxylation products of dihydric alcohols having from 2 to 5 carbon atoms with up to 60 alkylene oxide units per molecule, glycerol or polyglycerol comprising up to 15 glycerol units per mole, erythritol or pentaerythritol.

The amount of epichlorohydrin used is preferably at least in the range from 2 to 8 mol per mole of one of the aforementioned at least dihydric alcohols. The reaction of di- or polyamine with chlorohydrin ether is then typically carried out at temperatures in the range from 1 to 200° C. Polyetherpolyamines useful as (C1) are also preparable by condensing diethanolamine or triethanolamine by conventional methods, see for example U.S. Pat. No. 4,404,362, U.S. Pat. No. 4,459,220 and U.S. Pat. No. 2,407,895.

Preference for use as (C1) is given to polyalkylenepolyamines which are if appropriate amidated to maximally 20 mol %, based on amidatable nitrogen atoms. Particular preference for use as (C1) is given to polyalkylenepolyamines, in particular polyethyleneimines, which very particularly preferably have an average molecular weight M_{w} in the range from 800 to 2 000 000 g/mol, more preferably in the range from 20 000 to 1 000 000 g/mol and very particularly preferably in the range from 20 000 to 750 000 g/mol, determined for example by light-scattering methods.

Auxiliary substance (C) is prepared by reacting at least one nitrogenous polymer (C1) with at least one carboxyalkylating reagent (C2). Carboxyalkylating reagents (C2) are selected from

α,β-unsaturated carboxyl compounds whose carboxyl groups may be free or capped, α-halocarboxyl compounds whose carboxyl groups may be free or capped,

glycidylcarboxyl compounds whose carboxyl groups may be free or capped,

cyanohydrins

and mixtures of at least one aldehyde and at least one alkali metal cyanide.

Useful (C2) α,β-unsaturated carboxyl compounds, whose carboxyl groups may be free or capped, include for example monoethylenically unsaturated α,β-unsaturated carboxyl compounds which preferably have from 3 to 20 carbon atoms in the alkenyl radical. α,β-Unsaturated carboxyl compounds whose carboxyl groups may be free or capped are selected from α,β-unsaturated carboxylic acids, their salts, esters, amides or nitrites.

Useful (C2) α,β-unsaturated carboxylic acids include for example acrylic acid, methacrylic acid, 3,3-dimethylacrylic acid, ethylacrylic acid, maleic acid, fumaric acid, itaconic acid, cinnamic acid, methylenemalonic acid and citraconic acid. Multiply ethylenically unsaturated carboxylic acids such as for example sorbic acid are also suitable. (C2) is preferably selected from acrylic acid, methacrylic acid and maleic acid.

Salts of the aforementioned a,p-unsaturated carboxylic acids are further useful as (C2). Useful salts include for example the alkali metal, alkaline earth metal and ammonium salts of the aforementioned a,p-unsaturated carboxylic acids. The sodium, potassium and ammonium salts are preferred. Ammonium salts can be derived not only from ammonia but also from amines or amine derivatives such as ethanolamine, diethanolamine and triethanolamine. Useful alkaline earth metal salts include in general magnesium and calcium salts of the aforementioned α,β-unsaturated carboxylic acids.

Useful (C2) esters of the aforementioned α,β-unsaturated carboxylic acids are preferably derived from monohydric C₁-C₂₀-alcohols or dihydric C₂-C₆-alkanediols. Useful (C2) esters include for example: methyl(meth)acrylate, ethyl(meth)acrylate, n-propyl(meth)acrylate, isopropyl(meth)acrylate, n-butyl(meth)acrylate, isobutyl(meth)acrylate, 2-ethylhexyl(meth)acrylate, palmityl(meth)acrylate, lauryl(meth)acrylate, dimethyl maleate, diethyl maleate, mono- and diisopropyl maleate, 2-hydroxy-n-propyl(meth)acrylate, 3-hydroxypropyl(meth)acrylate, 4-hydroxybutyl(meth)acrylate and 6-hydroxyhexyl(meth)acrylate.

Useful (C2) nitrites of aforementioned α,β-unsaturated carboxylic acids are preferably acrylonitrile and methacrylonitrile.

Useful (C2) amides of aforementioned α,β-unsaturated carboxylic acids are for example acrylamide and methacrylamide.

Useful (C2) carboxyalkylating reagents further include α-halocarboxyl compounds whose carboxyl groups may be free or capped. Useful α-halocarboxyl compounds are preferably α-halocarboxyl acids such as for example α-chlorocarboxylic acids. Useful α-chlorocarboxylic acids are for example chloroacetic acid, 2-chloropropionic acid, 3-chloropropionic acid, 2-chlorobutyric acid, 3-chlorobutyric acid, 4-chlorobutyric acid, dichloroacetic acid and 2,2-dichloropropionic acid. Further suitable α-halocarboxyl compounds, whose carboxyl groups may be free or capped, are C₁-C₁₀-alkyl chloroacetate, C₁-C₁₀-alkyl 2-chloropropionate, C₁-C₁₀-alkyl 2-chlorobutyrate, C₁-C₁₀-alkyl dichloroacetate, 2,2-dichlorpropionic acid and chloroacetonitrile.

Useful (C2) carboxyalkylating reagents further include glycidylcarboxyl compounds which preferably have the formula III:

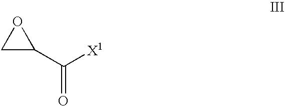

where
X¹ is NH₂, OH, OM², OR³
M² is selected from one equivalent of ammonium or alkali metal ion, in particular Na⁺ or K⁺, and half an equivalent of Mg²⁺ and Ca²⁺,
R³ is C₁-C₁₀-alkyl, branched or unbranched, or C₂-C₄-hydroxyalkyl, in particular C₂-C₄-ω-hydroxyalkyl.

Preferred compounds of the formula V are glycidic acid and its sodium, potassium, ammonium, magnesium or calcium salts, glycidamide and glycidic esters, in particular C₁-C₁₀-alkyl glycidates such as methyl glycidate, ethyl glycidate, n-propyl glycidate, n-butyl glycidate, isobutyl glycidate, 2-ethylhexyl glycidate, 2-hydroxypropyl glycidate and 4-hydroxybutyl glycidate. Particular preference is given to glycidic acid, its sodium, potassium and ammonium salts and glycidamide.

Useful carboxyalkylating reagents (C2) further include cyanohydrins, for example mandelonitrile and hydroxyacetonitrile.

Useful carboxyalkylating reagents (C2) further include mixtures of at least one aldehyde and at least one alkali metal cyanide.

Useful aldehydes are for example C₁-C₁₀-alkanals, preferably acetaldehyde and more preferably formaldehyde, and aromatic aldehydes such as benzaldehyde for example.

Useful alkali metal cyanides are for example potassium cyanide and sodium cyanide.

The carboxyalkylation of nitrogenous polymer (C1) with at least one carboxyalkylating reagent (C2) can be effected for example by conventional methods, for example as described in WO 97/40087. The carboxyalkylation of nitrogenous polymer (C1) with at least one carboxyalkylating reagent (C2) in a preferred embodiment is done by feeding aldehyde and alkali metal cyanide concurrently into an aqueous solution of nitrogenous polymer (C1) in the course of 0.5 to 10 hours for example, a small excess of alkali metal cyanide in the reaction mixture being preferred. For example, a small amount of alkali metal cyanide, for example from 2 to 10 mol %, based on N—H groups in nitrogenous polymer (C1), is introduced in the reaction mixture as a part of an initial charge and subsequently nitrogeneous polymer (C1), aldehyde and alkali metal cyanide in a molar ratio of about 1:1 are added separately or as a mixture.

In theory, one mole of aldehyde and one mole of alkali metal cyanide are reacted per mole of NH groups in nitrogenous polymer (C1). Since a lower degree of carboxyalkylation is sought, a molar deficiency in the range from 0.2 to 0.95 mol of aldehyde and preferably up to 0.85 mol of aldehyde and from 0.2 to 0.95 mol of alkali metal cyanide and preferably up to 0.85 mol of alkali metal cyanide are used based on one mole of NH groups in nitrogenous polymer (C1). The carboxyalkylation may be carried out as a continuous operation or as a batch operation or as a semicontinuous operation.

Very particular preference for use as (C2) is given to a monoethylenically unsaturated carboxylic acid, more preferably acrylic acid, methacrylic acid or maleic acid, most preferably acrylic acid.

When carboxyalkylating reagent (C2) having a capped carboxyl group, for example having a nitrile group, is used or carboxyalkylating reagent (C2) having carboxyl groups in the form of for example ester or amide groups, the reaction of nitrogenous polymer (C1) with carboxyalkylating reagent (C2) and if appropriate at least one bifunctional crosslinker (C3) is followed by a hydrolysis.

Useful as (C3) are at least bifunctional crosslinkers comprising at least one halohydrin, glycidyl, aziridine or isocyanate unit or at least one halogen atom per molecule as a functional group. The functional groups in (C3) may each be the same or different.

At least bifunctional crosslinkers useful as (C3) are for example epihalohydrins, preferably epichlorohydrin, and also α,ω-bis(chlorohydrin) polyalkylene glycol ethers and the α,ω-bisepoxides (of polyalkylene glycol ethers) obtainable therefrom by treatment with bases. α,ω-Bis(chlorohydrin) polyalkylene glycol ethers are prepared for example by reacting polyalkylene glycols with epichlorohydrin in a molar ratio of 1 :at least 2-5. Useful polyalkylene glycols are for example polyethylene glycol, polypropylene glycol and polybutylene glycols and also block copolymers of C₂-C₄-alkylene oxides. The average molecular weight M_{w} of polyalkylene glycol useful for preparing (C3) can be in the range from 100 to 6000 g/mol and preferably in the range from 300 to 2000 g/mol. α,ω-Bis(chiorohydrin) polyalkylene glycol ethers and methods of making them are described for example in U.S. Pat. No. 4,144,123. Treatment with bases makes it possible to convert α,ω-bis(chlorohydrin) polyalkylene glycol ethers into the corresponding α,ω-bisepoxides of polyalkylene glycol ethers, which are likewise useful as bifunctional crosslinkers (C3).

Useful at least bifunctional crosslinkers (C3) further include α,ω-dichloropolyalkylene glycols as described for example in EP-A 0 025 515. Suitable α,ω-dichloropolyalkylene glycols are preparable for example by reacting dihydric, trihydric or tetrahydric alcohols, preferably alkoxylated dihydric, trihydric or tetrahydric alcohols, either with thionyl chloride by HCl elimination and subsequent for example catalytic decomposition of the corresponding bischlorosulfonates by elimination of sulfur dioxide, or with phosgene by HCl elimination to form the corresponding bischlorocarbonic esters and their subsequent catalytic decomposition by elimination of carbon dioxide to form α,ω-dichloropolyalkylene glycols. Alkoxylated dihydric, trihydric or tetrahydric alcohols are preferably ethoxylated and/or propoxylated glycol, glycerol or pentaerythritol which have been reacted with from 1 to 100 and in particular from 4 to 40 mol of ethylene oxide or propylene oxide per mole of glycol.

Useful at least bifunctional crosslinkers (C3) further include α,ω- or vicinal dichloroalkanes, examples being 1,2-dichloroethane, 1-bromo-2-chloroethane, 1,2-dichloropropane, 1,3-dichloropropane, 1,4-dichlorobutane and 1,6-dichlorohexane. Useful at least bifunctional crosslinkers (C3) further include reaction products of at least trihydric alcohols with epichlorohydrin which have at least two chlorohydrin units. Useful polyhydric alcohols include for example glycerol, singly or multiply ethoxylated and/or propoxylated glycerols, polyglycerols having from 2 to 15 glycerol units per molecule and also if appropriate ethoxylated and/or propoxylated polyglycerols which are known as such from DE-A 29 16 356 for example.

Useful at least bifunctional crosslinkers (C3) further include those comprising blocked or unblocked isocyanate groups, an example being trimethylhexamethylene diisocyanate blocked by 2,2,3,6-tetramethyl-4-piperidinone. Such at least bifunctional crosslinkers (C3) are known as such from DE-A 40 28 285 for example. Useful at least bifunctional crosslinkers (C3) further include those comprising aziridine units, for example those based on polyethers or substituted hydrocarbons, an example being 1,6-bis-N-aziridinohexane.

Particularly preferred at least bifunctional crosslinkers (C3) are epihalohydrins, preferably epichlorohydrin, α,ω-bis(chlorohydrin) polyalkylene glycol ethers, α,ω-bisepoxides of polyalkylene glycol ether and/or bisglycidyl ethers of polyalkylene glycols.

One embodiment of the present invention utilizes an at least bifunctional crosslinker (C3) to prepare auxiliary substance (C).

Another embodiment of the present invention utilizes mixtures of two or more at least bifunctional crosslinkers (C3) to prepare auxiliary substance (C).

Another embodiment of the present invention selects (C1) from polyalkyleneamines and in particular polyethyleneimines and makes it possible to dispense with at least bifunctional crosslinker (C3) in the preparation of auxiliary substance (C).

Auxiliary substance (C) is preparable by methods known per se. For example, initially (C1) is reacted with (C2) and then (C3) is added. Alternatively, (C3) and (C2) may be reacted simultaneously with (C1). It is preferable first to react (C1) with (C3) and then to add (C2).

In one embodiment of the present invention the reaction of (C1) with (C2) and if appropriate (C3) is carried out at temperatures in the range from 30° C. to 150° C. and preferably in the range from 55° C. to 100° C.

In one embodiment of the present invention the reaction of (C1) with (C2) and if appropriate (C3) is carried out at pressures in the range from 0.1 to 10 bar and more preferably at atmospheric pressure in the range from 1 to 5 bar.

In one embodiment of the present invention the reaction of (C1) with (C2) and if appropriate (C3) is carried out in aqueous medium in which one or more organic solvents may be comprised. Preferably, however, the reaction of (C1) with (C2) and if appropriate (C3) does not utilize organic solvents and is carried out in water.

In one embodiment of the present invention the reaction of (C1) with (C2) is carried out in the presence of at least one free-radical scavenger, for example hydroquinone, hydroquinone monomethyl ether, phenothiazine, hindered amines (HALS) such as for example 2,2,6,6-tetramethylpiperidine, or substituted phenols such as for example 2,6-di-tert-butylphenol.

In one embodiment of the present invention the reaction of (C1) with (C2) is carried out in the presence of strong base, for example sodium hydroxide or potassium hydroxide.

The molar ratio between the components (C1) and (C2) is preferably chosen so that the molar ratio of the hydrogen atoms on the nitrogen in (C1) to component (C2) is in the range from 1:0.2 to 1:0.95, preferably in the range from 1:0.3 to 1:0.9 and more preferably in the range from 1:0.4 to 1:0.85.

In one embodiment of the present invention auxiliary substance (C) used according to the present invention comprises incipiently crosslinked polymers in that from 0.1 to 10 mol %, preferably up to 5 mol % and more preferably up to 2 mol % of the N—H bonds comprised in nitrogenous polymer (C1) have been reacted with at least one at least bifunctional crosslinker (C3).

In one embodiment of the present invention auxiliary substance (C) has a molecular weight M_{w} in the range from 1000 to 2 000 000 g/mol, and preferably in the range from 20 000 to 1 000 000 g/mol.

Auxiliary substance (C) is typically obtained as an aqueous solution or dispersion from which auxiliary substance (C) can be isolated and purified by methods known per se. In many cases, however, the resulting aqueous solution of auxiliary substance (C) can be used to prepare inventive aqueous formulation and purifying steps can be dispensed with.

One specific embodiment of the present invention comprises conducting the process of the present invention as an ink jet process by the transfer printing process by an ink jet ink comprising at least one disperse dye as dispersed substance (A) and at least one auxiliary substance (C) being applied to a transfer paper as substrate (B),

the pKₐ value of auxiliary substance (C) wherein is higher than that of the transfer paper as substrate (B) and of disperse dye if appropriate in combination with at least one dispersant as dispersed substance (A)

and wherein auxiliary substance (C) is selected from three-dimensional amphoteric core-shell polymers,

and subsequently transferred at temperatures in the range from 150 to 250° C. preferably by sublimation to a second substrate capable of molecularly dissolving disperse dyes such as for example polyamide, polyacrylonitrile, viscose, acetate and preferably polyester, in particular synthetic fibers for example of polyamide, viscose acetate and/or polyester.

One embodiment of the present invention attains the temperatures in the range from 150 to 250° C. by utilizing a transfer press or a calender.

The present invention further provides formulations, preferably aqueous formulations, comprising

at least one dissolved or dispersed substance (A) and

at least one auxiliary substance (C) wherein the pKₐ value of auxiliary substance (C) is higher than that of dissolved or dispersed substance (A)

and wherein auxiliary substance (C) is selected from three-dimensional amphoteric core-shell polymers.

Dissolved or dispersed substance (A) and auxiliary substance (C) and also methods of making them are described above.

In one embodiment of the present invention three-dimensional amphoteric core-shell polymers chosen as auxiliary substance (C) comprise partially crosslinked chemically modified polymer having cationic core.

In one embodiment of the present invention dissolved or dispersed substance (A) comprises a disperse dye.

In one embodiment of the present invention dissolved or dispersed substance (A) comprises a substance having SO₃⁻ or OSO₃⁻ groups.

In one preferred embodiment of the present invention auxiliary substance (C) is obtainable by reaction of
(C1) at least one nitrogenous polymer selected from polyalkylenepolyamines, polyamidoamines, ethyleneimine-grafted polyamidoamines, polyetheramines, with
(C2) at least one carboxyalkylating reagent selected from α,β-unsaturated carboxyl compounds whose carboxyl groups may be free or capped, α-halocarboxyl compounds whose carboxyl groups may be free or capped, glycidylcarboxyl compounds whose carboxyl groups may be free or capped,
   cyanohydrins and mixtures of at least one aldehyde and at least one alkali metal cyanide,
(C3) and if appropriate at least one at least bifunctional crosslinker whose functional groups are selected from halohydrin, glycidyl, aziridine or isocyanate units or halogen atoms.

In one embodiment of the present invention inventive preferably aqueous formulations comprise

from 0.01% to 40% by weight, preferably from 0.05% to 30% by weight and more preferably from 0. 1% to 20% by weight of dissolved/dispersed substance (A) and from 0.001% to 20% by weight, preferably from 0.01 % to 10% by weight and more preferably from 0. 1% to 1% by weight of auxiliary substance (C), all based on total inventive formulation.

Ink jet process inks comprising at least one inventive preferably aqueous formulation are a specific aspect of the present invention.

Inventive inks for the ink jet process comprise at least one dissolved or preferably dispersed substance (A) and at least one auxiliary substance (C), the pKₐ value of auxiliary substance (C) being greater than that of dissolved or dispersed substance (A) and auxiliary substance (C) being selected from three-dimensional amphoteric core-shell polymers.

Ink sets comprising a plurality of inventive inks for the ink jet process are a further aspect of the present invention. Inventive ink sets comprise no additional liquid comprising an anionic polymer such as for example poly(meth)acrylic acid or styrene-(meth)acrylic acid copolymer.

In one embodiment of the present invention inventive preferably aqueous formulations and in particular inventive inks for the ink jet process may further comprise at least one extra (D).

Herein, inks for the ink jet process are also referred to as ink jet inks or briefly as inks.

In one embodiment of the present invention inventive ink jet inks are prepared by inventive preferably aqueous formulation being diluted with water and if appropriate mixed with one or more extras (D).

In one embodiment of the present invention the solids content of inventive ink jet inks is adjusted to be in the range from 3% to 40%, preferably in the range up to 35% and more preferably in the range from 5% to 30%.

Ink jet process inks according to the present invention may comprise one or more organic solvents as extra (D). Low molecular weight polytetrahydrofuran (poly-THF) is a preferred extra (D), it can be used alone or preferably in a mixture with one or more high-boiling, water-soluble or water-miscible organic solvents.

The average molecular weight M_{w} of preferred low molecular weight polytetrahydrofuran is typically in the range from 150 to 500 g/mol, preferably in the range from 200 to 300 g/mol and more preferably about 250 g/mol (in keeping with a molecular weight distribution).

Polytetrahydrofuran is preparable in a known manner by cationic polymerization of tetrahydrofuran. The products are linear polytetramethylene glycols.

When polytetrahydrofuran is used as an extra (D) in a mixture with further organic solvents, the further organic solvents employed will generally be high-boiling (i.e., boiling point >100° C. at atmospheric pressure, in general) and hence water-retaining organic solvents which are soluble in or miscible with water.

Useful solvents include polyhydric alcohols, preferably unbranched and branched polyhydric alcohols having from 2 to 8 and especially from 3 to 6 carbon atoms, such as ethylene glycol, 1,2-propylene glycol, 1,3-propylene glycol, glycerol, erythritol, 1,1,1-trimethyidpropane pentaerythritol, pentitols such as arabitol, adonitol and xylitol and hexitols such as sorbitol, mannitol and dulcitol.

Useful solvents further include polyethylene glycols and polypropylene glycols including their lower polymers (di-, tri- and tetramers) and their mono(especially C₁-C₆ and especially C₁-C₄)alkyl ethers. Preference is given to polyethylene and polypropylene glycols having average molecular weights M, in the range from 100 to 6000 g/mol, especially up to 1500 g/mol and in particular in the range from 150 to 500 g/mol. As examples there may be mentioned diethylene glycol, triethylene glycol and tetraethylene glycol, diethylene glycol monomethyl ether, diethylene glycol monoethyl ether, diethylene glycol mono-n-propyl ether, diethylene glycol monoisopropyl ether, diethylene glycol monopropyl ether, diethylene glycol mono-n-butyl ether, triethylene glycol monomethyl ether, triethylene glycol monoethyl ether, triethylene glycol mono-n-propyl ether, triethylene glycol monoisopropyl ether, triethylene glycol mono-n-butyl ether, di-, tri- and tetra-1,2- and -1,3-propylene glycol and di-, tri- and tetra-1,2- and -1,3-propylene glycol monomethyl, monoethyl, mono-n-propyl, monoisopropyl and mono-n-butyl ethers.

Useful extras (D) further include pyrrolidone and N-alkylpyrrolidones whose alkyl chain preferably comprises from 1 to 4 and in particular 1 or 2 carbon atoms. Examples of useful alkylpyrrolidones are N-methylpyrrolidone, N-ethylpyrrolidone and N-(2-hydroxyethyl)pyrrolidone.

Examples of particularly preferred solvents are 1,2-propylene glycol, 1,3-propylene glycol, glycerol, sorbitol, diethylene glycol, polyethylene glycol (M_{w} 150 to 500 g/mol), diethylene glycol monobutyl ether, triethylene glycol monobutyl ether, pyrrolidone, N-methylpyrrolidone and N-(2-hydroxyethyl)pyrrolidone.

Polytetrahydrofuran can also be mixed with one or more (for example two, three or four) of the solvents recited above.

In one embodiment of the present invention, ink jet process inks according to the present invention may comprise from 0.1% to 80% by weight, preferably from 2% to 60% by weight, more preferably from 5% to 50% by weight and most preferably from 10% to 40% by weight of nonaqueous solvents.

Nonaqueous solvents used as extras (D), including in particular the identified particularly preferred solvent combinations, may advantageously be supplemented with urea (generally in the range from 0.5% to 5% by weight, based on the weight of the formulation) to further enhance the water-retaining effect of the solvent mixture.

Ink jet process inks according to the present invention may comprise further extras (D) of the kind which are customary especially for aqueous ink jet inks and in the printing and coatings industries. Examples include preservatives such as for example 1,2-benzisothiazolin-3-one (commercially available as Proxel brands from Avecia Lim.) and its alkali metal salts, glutaraldehyde and/or tetramethylolacetylenediurea, Protectols®, antioxidants, degassers/defoamers such as for example acetylenediols and ethoxylated acetylenediols, which typically comprise from 20 to 40 mol of ethylene oxide per mole of acetylenediol and may also have a dispersing effect, viscosity regulators, flow agents, wetters (for example wetting surfactants based on ethoxylated or propoxylated fatty or oxo alcohols, propylene oxide-ethylene oxide block copolymers, ethoxylates of oleic acid or alkylphenols, alkylphenol ether sulfates, alkylpolyglycosides, alkyl phosphonates, alkylphenyl phosphonates, alkyl phosphates, alkylphenyl phosphates or preferably polyethersiloxane copolymers, especially alkoxylated 2-(3-hydroxypropyl)heptamethyltrisiloxanes, which generally comprise a block of 7 to 20 and preferably 7 to 12 ethylene oxide units and a block of 2 to 20 and preferably 2 to 10 propylene oxide units and may be comprised in the colorant preparations in amounts from 0.05% to 1% by weight), anti-seftlers, luster improvers, glidants, adhesion improvers, anti-skinning agents, delusterants, emulsifiers, stabilizers, hydrophobicizers, light control additives, hand improvers, antistats, bases such as for example triethanolamine or acids, specifically carboxylic acids such as for example lactic acid or citric acid to regulate the pH. When these agents are a constituent part of ink jet process inks according to the present invention, their total amount will generally be 2% by weight and especially 1% by weight, based on the weight of the present invention's colorant preparations and especially of the present invention's inks for the ink jet process.

Useful extras (D) further include alkoxylated or nonalkoxylated acetylenediols, for example of the general formula VI

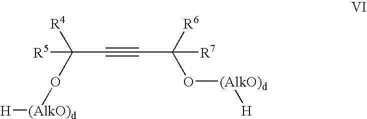

where
AlkO represents identical or different alkylene oxide units, for example propylene oxide units, butylene oxide units and especially ethylene oxide units,
R⁴ R⁵, R⁶ and R⁷ are each the same or different and selected from C₁-C10-alkyl, branched or unbranched, such as methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, n-octyl, 2-ethylhexyl, n-nonyl, n-decyl, more preferably C₁-C₄-alkyl such as methyl, ethyl, n-propyl, isopropyl, n-butyl, isobutyl, sec-butyl and tert-butyl; and hydrogen;
d is in each occurrence the same or different and selected from integers in the range from 0 to 50, preferably 0 or 1 to 30 and more preferably 3 to 20.

In a preferred embodiment of the present invention, R⁵ or R⁷ are methyl.

In a preferred embodiment of the present invention, R⁵ and R⁷ are methyl and R⁴ and R⁶ are isobutyl.

Other preferred extras (D) are alkoxylated or nonalkoxylated silicon compounds of the formula from VII a to VII d

[(CH₃)₃Si—O]₂—Si(CH₃)—(CH₂)₃—O(CH₂CH₂O)_{d}—H VII a

H(OCH₂CH₂)_{d}—O—(CH₂)₃—Si(CH₃)[OSi(CH₃)₃][OSi(CH₃)₂—OSi(CH₃)₃] VII b

H(PO)_{d}—(OCH₂CH₂)_{d}—O—(CH₂)₃—Si(CH₃)[OSi(CH₃)₂—OSi(CH₃)₃]₂ VII c

H(PO)_{d}—(OCH₂CH₂)_{d}—O—(CH₂)₃—Si(CH₃)[OSi(CH₃)₃][OSi(CH₃)₂]ᵤ—OSi(CH₃)₃ VII d

where d is in each occurrence the same or different and as defined above and u is an integer in the range from 1 to 10.

Ink jet process inks according to the present invention in one embodiment of the present invention have a dynamic viscosity in the range from 2 to 80 mPa·s, preferably from 3 to 40 mPa·s, and more preferably up to 30 mPa·s, measured at 23° C. in accordance with German standard specification DIN 53018.

The surface tension of ink jet process inks according to the present invention in one embodiment of the present invention is in the range from 24 to 70 mN/m and especially in the range from 25 to 60 mN/m, measured at 25° C. in accordance with German standard specification DIN 53993.

The pH of ink jet process inks according to the present invention in one embodiment of the present invention is in the range from 5 to 10 and preferably in the range from 7 to 9.

Ink jet process inks according to the present invention have altogether advantageous performance characteristics, in particular good start-of-print performance and good sustained use performance (kogation) and also, especially when the particularly preferred solvent combination is used, good drying performance, and produce printed images of high quality, i.e., of high brilliance and depth of shade and also high dry rub, light, water and wet rub fastness.

In a further embodiment of the present invention at least two and preferably at least three different inventive inks for the ink jet process can be combined to form ink sets wherein different inventive ink jet inks each comprise different colorants each having a different color, for example yellow, magenta, cyan and black.

The present invention further provides a process for producing inventive preferably aqueous formulations, hereinafter also referred to as inventive process of production.

In one embodiment the inventive process of production is carried out by at least one substance (A) being dissolved or dispersed in a polar and preferably aqueous medium and mixed with at least one auxiliary substance (C).

Polar medium can be for example alcohol, preferably methanol or ethanol or isopropanol.

Aqueous medium for the purposes of the present invention can be either pure water or preferably an aqueous solution of extras (D) as customary for example in coating processes or printing processes, in particular in printing processes by the ink jet process. Preferred extras (D) for the ink jet process are recited above.

It is also possible of course to use mixtures of water and methanol or water and ethanol or water and isopropanol as polar medium.

In one specific embodiment of the present invention the inventive process of production is carried out by at least one substance (A) in a polar and preferably aqueous medium mixed with at least one auxiliary substance (C) being dispersed, for example in a ball mill.

The present invention further provides substrates printed by the process of the present invention. Printed substrates according to the present invention are notable for very good rub fastnesses, such as for example dry rub fastness and wet rub fastness and also for remarkably crisp lines for applied dissolved or dispersed substance (A).

The present invention further provides for the use of inventive printed substrates as a transfer medium in the transfer printing process.

The present invention further provides a process for coloring polyester or polyester-containing materials by the transfer printing process by using inventive printed substrates as a transfer medium wherein substrate (B) is preferably a transfer paper having a pKₐ value in the range from 4 to 6.

The present invention further provides substrates composed of polyamide, polyacrylonitrile, viscose, acetate and preferably polyester or polyester-containing material, colored by using inventive printed substrates or by an inventive process. Inventive colored substrates composed of polyamide, polyacrylonitrile, viscose, acetate and preferably polyester or polyester-containing material are notable for very good rub fastnesses such as for example dry rub fastness and wet rub fastness and also for remarkably sharp lines for applied dissolved or disperse substance (A). More particularly, patterns are transferable particularly effectively and brightly to substrates composed of polyamide, polyacrylonitrile, viscose, acetate and preferably polyester or polyester-containing material.

The invention is illustrated by worked examples.

General Preliminaries:

Solids content: % ages in the realm of the present invention are all % by weight, unless expressly stated otherwise.

Fikentscher's K value is a measure of the molecular weight of for example auxiliary substances (C) and was determined in accordance with H. Fikentscher, Cellulose-Chemie, 13, 38 to 64 and 71 to 74 (1932) as a 1% by weight solution in water at 23° C.

I. Preparation of Auxiliary Substances (C)

I.1. Preparation of Auxiliary Substance C-1

A four-neck flask equipped with metal stirrer and reflux condenser was charged with 196 g of polyethyleneimine (C1.1, anhydrous, M_{w} 25 000 g/mol) under nitrogen. 588 g of distilled water were added under nitrogen to dilute the polyethyleneimine to 25% by weight. The mixture was heated to 70° C. with stirring and 40 ml of a 22% by weight aqueous solution of C3.1 were added at 70° C. in the course of 5 minutes. C3.1 was a reaction product of a polyethylene glycol having M_{w} 1500 g/mol with 2 equivalents of epichlorohydrin. On completion of the addition of C3.1 the reaction mixture was stirred at 70° C. for 5 hours. The temperature was then raised to 80° C. and 263.2 g of acrylic acid (C2.1) were added dropwise at 80° C. in the course of 3 hours. On completion of the addition the reaction mixture thus obtainable was stirred at 80° C. for a further 1 hour and thereafter cooled down to room temperature to leave a yellowish orange viscous solution of auxiliary substance C-1 having a solids content of 42% (2 h, vacuum/120° C.) and a Fikentscher K value (1% in water) of 17.

The pKₐ value of auxiliary substance C-1 was 6.3.

I.2. Preparation of Auxiliary Substance C-2

A four-neck flask equipped with metal stirrer and reflux condenser was charged with 350 g of a 56% by weight aqueous solution of polyethyleneimine (C1.1, M_{w} 25 000 g/mol) under nitrogen. 456 g of distilled water were added under nitrogen to dilute the polyethyleneimine to 24% by weight. The mixture was heated to 80° C. with stirring and 259.4 g of acrylic acid (C2.1) were added dropwise at 80° C. in the course of 3 hours. On completion of the addition, the solution was stirred at 80° C. for a further 6 hours to leave a yellowish orange viscous solution of auxiliary substance C-2 having a solids content of 43.2% (2 h, vacuum/120° C.) and a Fikentscher K value (1% in water) of 14.9.

The pKₐ value of auxiliary substance C-2 was 6.5.

I.3. Preparation of Auxiliary Substance C-3

A four-neck flask equipped with metal stirrer and reflux condenser was charged with 350 g of a 56% by weight aqueous solution of polyethyleneimine (C1.1, M_{w} 25 000 g/mol) under nitrogen. 456 g of distilled water were added under nitrogen to dilute the polyethyleneimine. The mixture was heated to 70° C. with stirring and 18 ml of a 50% by weight aqueous solution of C3.3 were added at 700C in the course of 5 minutes. C3.3 was a reaction product of a polyethylene glycol having average molecular weight M_{w} 660 g/mol with 2 equivalents of epichlorohydrin. On completion of the addition, the reaction mixture was stirred at 70° C. for 5 hours. The reaction mixture was then heated to 80° C. and 259.4 g of acrylic acid (C2.1) were added dropwise at 80° C. in the course of 3 hours. On completion of the addition, the reaction mixture was stirred at 95° C. for a further hour and thereafter cooled down to room temperature to leave a yellowish orange viscous solution of auxiliary substance C-3 having a solids content of 44.1% (2 h, vacuum/120° C.) and a Fikentscher K value (1% in water) of 23.1.

The pKₐ value of auxiliary substance C-3 was 6.4.

II. Production of Inventive Inks for Ink Jet Process

Ingredients as per Table 1 were mixed in a glass beaker. All amounts in g unless otherwise stated. The inventive inks T1 to T8 were obtained.

TABLE 1
Composition of inventive inks T1 to T4

| | T1 | T2 | T3 | T4 |
|---|---|---|---|---|
| | (cyan) | (magenta) | (yellow) | (black) |
| Disperse Blue 359 | 4.5 | | | |
| Disperse Red 60 | | 4.2 | | 0.5 |
| Disperse Yellow 54 | | | 3.5 | 0.5 |
| Disperse Blue 72 | | | | 2.8 |
| Dispersant 1 | 6 | 5.6 | 4.67 | 5.07 |
| C-1 | 0.35 | 0.3 | 0.25 | 0.4 |
| Diethylene glycol | 12.8 | 13.2 | 11.7 | 12.6 |
| Triethanolamine | 0.2 | 0.2 | 0.2 | 0.2 |
| Extra D1 | 4.5 | 4.2 | 3.5 | 3.8 |
| Extra D2 | 5.2 | 6.4 | 7.3 | 4.6 |
| Extra D3 | 0.3 | 0.28 | 0.23 | 0.25 |
| Extra D4 | 0.12 | 0.2 | 0.15 | 0.23 |
| Completely ion-free water | 66.03 | 65.42 | 68.5 | 69.05 |
| | T5 | T6 | T7 | T8 |
| | (cyan) | (magenta) | (yellow) | (black) |
| Disperse Blue 359 | 4.5 | | | |
| Disperse Red 60 | | 4.2 | | 0.5 |
| Disperse Yellow 54 | | | 3.5 | 0.5 |
| Disperse Blue 72 | | | | 2.8 |
| Dispersant 2 | 6 | 5.6 | 4.67 | 5.07 |
| C-2 | 0.52 | 0.48 | 0.41 | 0.32 |
| Glycerin | 11.4 | 12.3 | 10.2 | 11.3 |
| Triethanolamine | 0.25 | 0.25 | 0.25 | 0.25 |
| Extra D1 | 4.5 | 4.2 | 3.5 | 3.8 |
| Extra D5 | 6.5 | 7.7 | 8.5 | 5.9 |
| Extra D3 | 0.3 | 0.28 | 0.23 | 0.25 |
| Extra D6 | 0.1 | 0.15 | 0.1 | 0.15 |
| Completely ion-free water | 65.93 | 64.84 | 68.64 | 69.16 |

Key:
Dispersant 1: compound I b.1, pkₐ 2.2.

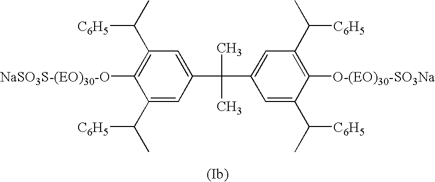

Extra D1: polyethylene glycol with M_{w} 1000 g/mol
Extra D2: polyethylene glycol with M_{w} 4000 g/mol
Extra D3: 20% by weight solution of 1,2-benzisothiazolin-3-one in
propylene glycol (biocide)
Extra D4: H(OCH₂CH₂)₇—O—(CH₂)₃—Si(CH₃)[OSi(CH₃)₃]₂
Dispersant 2: Naphthalenesulfonic acid-formaldehyde condensate with
M_{w} 20 000 g/mol, pkₐ 2.1.
Extra D5: Polyethylene glycol with M_{w} 4000 g/mol
Extra D6: H(OC₃H₆)₃—(OCH₂CH₂)₁₀—O—(CH₂)₃—
—Si(CH₃)[OSi(CH₃)₃][OSi(CH₃)₂]₃—OSi(CH₃)₃

III. Printing Tests with Inventive Inks

III.1 Printing Tests with Inventive Inks T1 to T4

Inventive inks T1 to T4 were printed with a Mimaki JV4 ink jet printer onto substrates B1 to B7 in line patterns, viz. stripes of any one ink T1 to T4 next to stripes of any one ink T1 to T3 or mixtures of two or three inks T1 to T3, and the bleeding of the respective inks at the borders of the stripes was measured in mm. The following results were obtained depending on the hereinbelow recited substrates:

III.1.1 Printing of Inventive Inks on Substrate B1

Substrate B1 was Coldenhove Jetcol HTR 2000 paper, pKₐ value: 4.9

TABLE 2.1
Printing of inventive inks T1 to T4 on substrate B1

| | T1 (cyan) | T2 (magenta) | T3 (yellow) | T4 (black) |
|---|---|---|---|---|
| T1/T2/T3 | 0.12 | 0.11 | 0.08 | 0.07 |
| T1/T2 | 0.06 | 0.08 | 0.09 | 0.07 |
| T1/T3 | 0.08 | 0.09 | 0.07 | 0.09 |
| T2/T3 | 0.06 | 0.07 | 0.06 | 0.05 |
| T1 | — | 0.04 | 0.06 | 0.05 |
| T2 | — | — | 0.07 | 0.03 |
| T3 | — | — | — | 0.04 |

III.1.2 Printing of Inventive Inks on Substrate B2

Substrate B2 was Coldenhove Jetcol HTR 4000 paper, pKₐ: 4.8

TABLE 2.2
Printing of inventive inks T1 to T4 on substrate B2

| | T1 (cyan) | T2 (magenta) | T3 (yellow) | T4 (black) |
|---|---|---|---|---|
| T1/T2/T3 | 0.14 | 0.1 | 0.09 | 0.08 |
| T1/T2 | 0.05 | 0.1 | 0.08 | 0.06 |
| T1/T3 | 0.06 | 0.09 | 0.07 | 0.07 |
| T2/T3 | 0.08 | 0.09 | 0.08 | 0.04 |
| T1 | — | 0.05 | 0.07 | 0.05 |
| T2 | — | — | 0.08 | 0.03 |
| T3 | — | — | — | 0.05 |

III.1.3 Printing of Inventive Inks on Substrate B3

Substrate B3 was Coldenhove Jetcol Highspeed paper, pKₐ: 5.0

TABLE 2.3
Printing of inventive inks T1 to T4 on substrate B3

| | T1 (cyan) | T2 (magenta) | T3 (yellow) | T4 (black) |
|---|---|---|---|---|
| T1/T2/T3 | 0.12 | 0.09 | 0.05 | 0.08 |
| T1/T2 | 0.07 | 0.09 | 0.09 | 0.06 |
| T1/T3 | 0.07 | 0.1 | 0.08 | 0.09 |
| T2/T3 | 0.05 | 0.06 | 0.07 | 0.06 |
| T1 | — | 0.03 | 0.05 | 0.06 |
| T2 | — | — | 0.08 | 0.04 |
| T3 | — | — | — | 0.03 |

III.1.4 Printing of Inventive Inks on Substrate B4

Substrate B4 was Cham Tenero Transjet 831 paper, pKₐ: 5.5

TABLE 2.4
Printing of inventive inks T1 to T4 on substrate B4

| | T1 (cyan) | T2 (magenta) | T3 (yellow) | T4 (black) |
|---|---|---|---|---|
| T1/T2/T3 | 0.14 | 0.12 | 0.07 | 0.07 |
| TI/T2 | 0.08 | 0.09 | 0.1 | 0.06 |
| T1/T3 | 0.08 | 0.09 | 0.06 | 0.08 |
| T2/T3 | 0.05 | 0.08 | 0.07 | 0.07 |
| T1 | — | 0.06 | 0.07 | 0.07 |
| T2 | — | — | 0.06 | 0.07 |
| T3 | — | — | — | 0.06 |

III.1.5 Comparative Test: Printing of Inventive Inks on Substrate B5

Substrate B5 was EPSON Photo Quality paper, pKₐ: 7.7

TABLE 2.5
Printing of inventive inks T1 to T4 on substrate B5

| | T1 (cyan) | T2 (magenta) | T3 (yellow) | T4 (black) |
|---|---|---|---|---|
| T1/T2/T3 | 1.7 | 1.9 | 1.6 | 2.1 |
| T1/T2 | 0.7 | 0.5 | 0.6 | 0.5 |
| T1/T3 | 0.9 | 1.0 | 0.8 | 0.95 |
| T2/T3 | 0.8 | 0.4 | 0.5 | 1.05 |
| T1 | — | 0.06 | 0.2 | 0.05 |
| T2 | — | — | 0.06 | 0.07 |

III.2 Printing of Inventive Inks T5 to T8

Inventive inks T5 to T8 were printed with a Mimaki JV4 ink jet printer onto substrates B1 to B7 in line patterns, viz. stripes of any one ink T5 to T8 next to stripes of any one ink T5 to T7 or mixtures of two or three inks T5 to T7, and the bleeding of the respective inks at the borders of the stripes was measured in mm. The following results were obtained depending on the hereinbelow recited substrates:

TABLE 3.1
Printing of inventive inks T5 to T8 on substrate B1

| | T5 (cyan) | T6 (magenta) | T7 (yellow) | T8 (black) |
|---|---|---|---|---|
| T5/T6/T7 | 0.15 | 0.12 | 0.09 | 0.09 |
| T5/T6 | 0.09 | 0.1 | 0.11 | 0.09 |
| T5/T7 | 0.11 | 0.09 | 0.1 | 0.12 |
| T6/T7 | 0.08 | 0.09 | 0.09 | 0.08 |
| T5 | — | 0.06 | 0.08 | 0.09 |
| T6 | — | — | 0.07 | 0.05 |
| T7 | — | — | — | 0.06 |

TABLE 3.2
Printing of inventive inks T5 to T8 on substrate B2

| | T5 (cyan) | T6 (magenta) | T7 (yellow) | T8 (black) |
|---|---|---|---|---|
| T5/T6/T7 | 0.16 | 0.13 | 0.12 | 0.1 |
| T5/T6 | 0.08 | 0.11 | 0.1 | 0.09 |
| T5/T7 | 0.06 | 0.12 | 0.09 | 0.08 |
| T6/T7 | 0.1 | 0.08 | 0.09 | 0.06 |
| T5 | — | 0.07 | 0.08 | 0.07 |
| T6 | — | — | 0.08 | 0.05 |
| T7 | — | — | — | 0.07 |

TABLE 3.3
Printing of inventive inks T5 to T8 on substrate B3

| | T5 (cyan) | T6 (magenta) | T7 (yellow) | T8 (black) |
|---|---|---|---|---|
| T5/T6/T7 | 0.13 | 0.1 | 0.08 | 0.09 |
| T5/T6 | 0.08 | 0.09 | 0.08 | 0.09 |
| T5/T7 | 0.06 | 0.11 | 0.09 | 0.11 |
| T6/T7 | 0.07 | 0.08 | 0.08 | 0.09 |
| T5 | — | 0.07 | 0.06 | 0.05 |
| T6 | — | — | 0.07 | 0.07 |
| T7 | — | — | — | 0.06 |

TABLE 3.4
Printing of inventive inks T5 to T8 on substrate B4

| | T5 (cyan) | T6 (magenta) | T7 (yellow) | T8 (black) |
|---|---|---|---|---|
| T5/T6/T7 | 0.15 | 0.13 | 0.09 | 0.1 |
| T5/T6 | 0.08 | 0.08 | 0.11 | 0.08 |
| T5/T7 | 0.07 | 0.1 | 0.07 | 0.09 |
| T6/T7 | 0.06 | 0.09 | 0.08 | 0.07 |
| T5 | — | 0.08 | 0.08 | 0.08 |
| T6 | — | — | 0.07 | 0.08 |
| T7 | — | — | — | 0.07 |

TABLE 3.5
Printing of inventive inks T5 to T8 on substrate B5
(comparative test)

| | T5 (cyan) | T6 (magenta) | T7 (yellow) | T8 (black) |
|---|---|---|---|---|
| T5/T6/T7 | 1.6 | 1.8 | 1.4 | 1.95 |
| T5/T6 | 0.55 | 0.8 | 0.7 | 0.5 |
| T5/T7 | 1.0 | 1.0 | 0.7 | 0.9 |
| T6/T7 | 0.6 | 0.55 | 0.5 | 0.95 |
| T5 | — | 0.1 | 0.05 | 0.2 |
| T6 | 0.08 | — | 0.1 | 0.1 |

The substrates printed with the inventive inks also possessed very good rub fastnesses.

1. A process for applying dissolved or dispersed substances (A) from a formulation in a polar medium to substrates (B) using at least one auxiliary substance (C) by a formulation in a polar medium comprising dissolved or dispersed substance (A) and at least one auxiliary substance (C) being applied to substrate (B), wherein the pKₐ value of auxiliary substance (C) is higher than that of substrate (B) and of dissolved or dispersed substance (A)
and wherein auxiliary substance (C) is selected from three-dimensional amphoteric core-shell polymers.

2. The process according to claim 1 wherein substrate (B) is contacted with a solution of anionic polymer neither immediately before nor immediately after the applying of formulation in a polar medium which comprises dissolved or dispersed substance (A) and at least one auxiliary substance (C).

3. The process according to claim 1 wherein substrates (B) are flexible substrates.

4. The process according to claim 1 wherein three-dimensional amphoteric core-shell polymers are partially crosslinked chemically modified polymer having cationic core.

5. The process according to claim 1 wherein dissolved or dispersed substance (A) comprises at least one anionic substance.

6. The process according to claim 1 wherein dissolved or dispersed substance (A) comprises a substance having at least one SO₃⁻ or OSO₃⁻ group per molecule.

7. The process according to claim 1 wherein dissolved or dispersed substance (A) is selected from water-soluble dyes, self-dispersing colorants, combinations of disperse dye with dispersant or combinations of pigment with dispersant.

8. The process according to claim 1 which is embodied as an ink jet process.

9. The process according to claim 1 wherein paper is selected as substrate (B).

10. The process according to claim 1 wherein auxiliary substance (C) is obtainable by reaction of
(C1) at least one nitrogenous polymer selected from polyalkylenepolyamines, polyamidoamines, ethyleneimine-grafted polyamidoamines, polyetheramines, with
(C2) at least one carboxyalkylating reagent selected from
α,β-unsaturated carboxyl compounds whose carboxyl groups may be free or capped, α-halocarboxyl compounds whose carboxyl groups may be free or capped, glycidylcarboxyl compounds whose carboxyl groups may be free or capped, cyanohydrins and mixtures of at least one aldehyde and at least one alkali metal cyanide,
(C3) and if appropriate at least one at least bifunctional crosslinker whose functional groups are selected from halohydrin, glycidyl, aziridine or isocyanate units or halogen atoms.

11. A formulation comprising at least one dissolved or dispersed substance (A) and at least one auxiliary substance (C) in a polar medium wherein the pKₐ value of auxiliary substance (C) is higher than that of dissolved or dispersed substance (A) and wherein auxiliary substance (C) is selected from three-dimensional amphoteric core-shell polymers.

12. The formulation according to claim 11 wherein three-dimensional amphoteric core-shell polymers comprise partially crosslinked chemically modified polymer having cationic core.

13. The formulation according to claim 11 wherein dissolved or dispersed substance (A) comprises a disperse dye.

14. The formulation according to claim 11 wherein dissolved or dispersed substance (A) comprises a substance having SO₃⁻ or OSO₃⁻ groups.

15. The formulation according to claim 11 wherein auxiliary substance (C) is obtainable by reaction of
(C1) at least one nitrogenous polymer selected from polyalkylenepolyamines, polyamidoamines, ethyleneimine-grafted polyamidoamines, polyetheramines, with
(C2) at least one carboxyalkylating reagent selected from
α,β-unsaturated carboxyl compounds whose carboxyl groups may be free or capped, α-halocarboxyl compounds whose carboxyl groups may be free or capped, glycidylcarboxyl compounds whose carboxyl groups may be free or capped, cyanohydrins and mixtures of at least one aldehyde and at least one alkali metal cyanide, and
(C3) if appropriate one at least bifunctional crosslinker whose functional groups are selected from halohydrin, glycidyl, aziridine or isocyanate units or halogen atoms.

16. An ink jet process ink comprising at least one aqueous formulation according to claim 11.

17. An ink jet process ink set comprising at least two inks according to claim 16.

18. A process for producing an aqueous formulation according to claim 11, which comprises at least one substance (A) being dissolved or dispersed in an aqueous medium and mixed with at least one auxiliary substance (C).

19. The process for printing substrates (B) by using at least one aqueous formulation according to claim 11.

20. A substrate treated by a process according to claim 1.

21. The method of using a printed substrate according to claim 20 as a transfer medium in the transfer printing process.

22. The process for coloring polyester or polyester-containing material by the transfer printing process by using a printed substrate according to claim 20 as a transfer medium.

23. Polyester or polyester-containing material colored using a printed substrate according to claim 20 or by a process according to claim 22.
